(19) United States
(12) Patent Application Publication
(10) Pub. No.: US 2026/0168551 A1
(43) Pub. Date: Jun. 18, 2026

(54) FRICTION MATERIAL COMPOSITION AND ASSOCIATED FRICTION ELEMENT

(71) Applicant: ITT Italia S.R.L., Milan (IT)

(72) Inventors: Valeria POLLIOTTO, Barge (IT); Milena ARABIA, Barge (IT); Laura RINALDI, Milan (IT); Paolo GALIMBERTI, Barge (IT)

(73) Assignee: ITT Italia S.R.L., Milan (IT)

(21) Appl. No.: 19/124,988

(22) PCT Filed: Nov. 16, 2023
(86) PCT No.: PCT/IB2023/061587

§ 371 Date: Apr. 28, 2025

(30) Foreign Application Priority Data
Nov. 18, 2022 (IT) 102022000023835

(51) Int. Cl. F16D 69/02; F16D 65/06; F16D 65/08; F16D 65/092

(52) U.S. Cl. CPC F16D 69/026; F16D 65/06; F16D 65/08; F16D 65/092; F16D 2200/0013; F16D 2200/0021; F16D 2200/003; F16D 2200/006

(57) ABSTRACT

An asbestos free friction material composition and associated brake pad for vehicles including inorganic and/or organic and/or metallic fibers, at least a binder, at least a friction modifier or lubricant, at least a filler or abrasive and at least a soluble salt of barium and/or calcium and/or aluminum and/or silver with percentage between 0.5-10% by weight. Among them barium carbonate, calcium hydroxide, aluminum triacetate and silver acetate are preferably.

### CROSS-REFERENCE TO RELATED APPLICATIONS

This patent application claims priority from Italian Patent Application No. 102022000023835 filed on Nov. 18, 2022, the entire disclosure of which is incorporated herein by reference.

### TECHNICAL FIELD

The present invention relates to a friction material composition particularly suitable for the manufacture of friction layers/blocks for friction elements such as braking elements to be incorporated, for example, in a vehicle braking system.

The invention also relates to an associated fiction element, for example brake pads or brake shoes for vehicles, made with this friction material composition.

The friction material composition of the present invention is free of asbestos, belonging to the so-called NAO (“Non-Asbestos Organic”) type, and is, particularly but not exclusively, free of copper.

### STATE OF THE ART

Friction materials free of asbestos fibers and aimed to be used on vehicle brake pads/shoes include five classes of components: a fibrous material consisting of inorganic and/or organic and/or metallic fibers, a binder, a filler, one or more lubricants or friction modifiers, one or more abrasives.

Fibrous materials that substitute asbestos may be both inorganic, such as rock fiber or rock wool, wollastonite, glass fibers, and organic, such us aramid fibers and carbon fibers, or metallic, such as steel fibers. The binder is usually a thermosetting polymer, such as for example based on phenolic resins. Various materials are used as fillers to give the friction material a sufficient strength, such as barite (barium sulfate), calcium carbonate, talc, magnesium oxide, vermiculite; as abrasives, zirconium silicate, zirconium oxide, alumina, silicon carbide, mica may be usually employed; as friction modifiers, metal sulfides such as molybdenum disulfide, iron sulfides, copper, tin, graphite and/or coke may be used. Other classes of materials may also be added in smaller percentages such as for example rubber in powder or granule form, “friction dust” (a well-known material readily available on the market), other organic materials.

The vehicle brake pads/shoes produced with friction materials as described above are however not free from drawbacks.

In particular, they can release ions in the environment when come into contact with water, which is quite common for a vehicle component assembled on/close to a vehicle wheel. In particular, known friction materials when in presence of water/humidity may release free ions as sulfates, sulfites, oxalates and phosphates.

Such release may be a major drawback. Firstly, the release of such kind of ions in the environment may cause pollution. Secondly, since such ions are released close to the brake disks, they may be a major cause of corrosion of the disk material, which is usually made of steel or cast iron.

The release of soluble sulfate ions from brake pads, for example, may promote steel/cast iron corrosion, since when in contact with ferrous materials they may cause the formation of the SO called “green rust” [Fe₄²⁺Fe₂³⁺(HO⁻)₁₂]²⁺*[SO₄²⁻·2H₂O]²⁻. Green rust compounds are believed to be intermediates in the oxidative corrosion of iron to form iron^{(III)} oxyhydroxides (so called “brown rust”).

Up to now, no solutions are known to eliminate the release of ions, such us sulphate, from brake pads/shoes, unless eliminating the source of those ions from the friction material formulation. For example, sulphate ions release could be eliminated by eliminating the use of sulfides in the friction material formulations. This solution is however unpractical, since the elimination of sulfides would have a great negative influence on the tribological properties of the final product, e.g., the friction material block present on the brake pad/shoe.

US2015192182A1 discloses the use in brake pad formulations of a modified activated carbon, which should be able to adsorb the sulfate ion in solution before they may chemically attack the ferrous material of the brake disk. However, this solution has proved to be not completely reliable and is complex and expensive to be implemented since both the activated carbon used as the adsorbent and the phenolic resin used as the binder are to be chemically modified in order to become hydrophilic.

### SUMMARY OF THE INVENTION

The object of the present invention is to develop a new asbestos free friction material composition, which is capable of overcoming the disadvantages of the prior art.

In particular, the presently disclosed subject matter is intended to provide an asbestos free friction material composition, which, though maintaining all the usual raw components, in order to have predictable brake performances, is substantially insensible to the ion release phenomenon when exposed to water or humidity.

It is therefore a further object of the invention to provide an associated brake element, in particular a brake pad or brake shoe, including such friction material composition able to avoid or at least strongly reduce in use the superficial corrosion of a friction partner cooperating therewith, like a brake disc or brake drum.

The invention is therefore related to a friction material composition and to an associated brake element as defined in the appended claims.

According to the present disclosure, to any friction material composition known to be subjected to the ion release amount specifically selected phenomenon a certain of chemical compounds of a metal which are soluble in water are added to the friction material standard composition itself to obtain a modified friction material composition which, when molded in a friction material block assembled to form a brake element like a brake pad or shoe, maintains all the chemical and physical characteristics of the corresponding standard composition, so ensuring fully predictable braking performances, while at the same time avoids or strongly reduces the superficial corrosion of the friction partner thereof, since the added chemical compounds of a metal is selected such that it chemically reacts with the ions eventually released by/in the composition forming water insoluble salts of such metal and such ions directly within/thereon the friction material block. In this manner, the released ions are unable to reach and attack the ferrous material of the friction partner.

Accordingly, t disclosure relates to an asbestos free friction material composition belonging to the class of friction materials known as NAO (Non Asbestos Organic), comprising as raw components thereof at least a fibrous material, at least one filler, at least one binder, at least one lubricant and/or other friction modifiers (preferably more than one lubricant and/or friction modifier), and at least one or more abrasives, wherein it further comprises at least one water soluble chemical compound of a metal able to react (e.g. by means of an exchange reaction) with anions normally present in/able to be released by one or more of the previous raw components forming therewith water insoluble salts of the metal and the ions.

With respect to a corresponding known NAO friction composition (i.e. having the same component materials for all the above well-known general classes of materials and in substantially the same quantity), the friction material composition of the present invention therefore further comprises a specific quantity of a water soluble chemical compound of a metal selected among those the metal of which is able to form water insoluble salts with the ions releasable from/in the friction material composition itself in presence of water and/or humidity.

In other words, the present invention consists in the addition to a (any) standard friction material composition of one or more metallic salts and/or hydroxides easily soluble in water and able, at the same time, to form water insoluble salts with sulfate, sulfite, oxalate and phosphate ions normally present in the friction material composition and/or possibly released thereby.

Here and in the following for “easily soluble” in water it is intended a chemical compound having solubility product constant, namely Kₚₛ, higher than 1*10⁻⁹, as specified in Clark, Roy W.; Bonicamp, Judith M. “Solubility and Solubility Products.” J. Chem. Educ. 2000 77 1558, in particular, it has to be higher than the solubility of the sulfate ion in the same solution and for the same cation.

According to preferred embodiments, the asbestos free friction material composition of the present disclosure comprises at least one water soluble chemical compound of barium and/or calcium and/or aluminum and/or silver, such as barium carbonate, calcium hydroxide, aluminum triacetate and silver acetate.

Such metallic chemical compounds have been surprisingly found in fact to have the ability to act as scavengers of any different ions that may be released from friction materials.

According to a most preferred embodiment, barium carbonate is used in an asbestos free friction material composition according to the invention as an additional component to be added to any per se known friction material composition, since barium contained in the BaCO₃ may form insoluble salt with any of sulphate, oxalates and phosphates and precipitate BaSO₄, Ba₃(PO₄)₂, BaC₂O₄ and BaCrO₄. Moreover, barium carbonate is a safe material easily available and not expensive.

It stems from the above that the present disclosure also relates to a brake element for a vehicle comprising a metallic support and a layer or block of friction material carried by the support, the block of friction material being made by the asbestos free friction material composition of the invention as disclosed above, preferably having been molded upon a first face of the support; and wherein the block of friction material is configured to retain in use, captured/sequestered within the friction material thereof or onto it any ion possibly released by one or more of the component materials of the friction material composition, in the form of a water insoluble metal salt without the possibility for the ions to reach a friction partner of the block of friction material, e.g. a brake disc, possibly causing a chemical etching of the ferrous material thereof.

The brake element according to the present disclosure is a brake pad or brake shoe for vehicles.

The disclosure also extends to a braking system comprising a member to be braked, constituted by a brake disc or brake drum made of cast iron or steel and by at least one braking member constituted by a brake pad or brake shoe, adapted to cooperate by friction with the member to be braked, wherein the braking member has a friction layer intended to cooperate with the member to be braked made of the friction material composition of the invention as disclosed above.

Further features and advantages of the disclosed subject matter, whether explicitly mentioned or not, will become apparent in view of the disclosure provided below, including practical and comparative non-limiting examples disclosing different possible and non-limiting embodiments thereof and with reference to the attached drawings, in which:

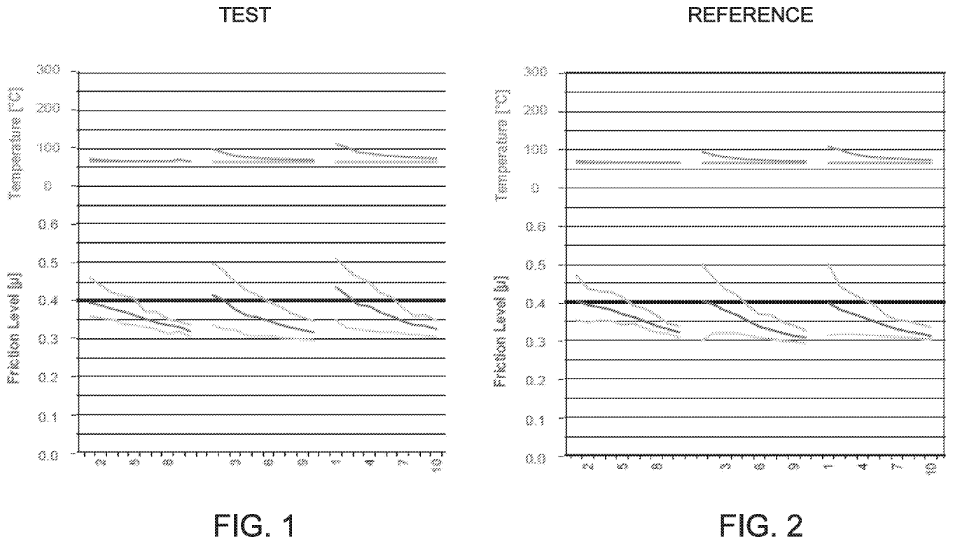

FIG. 1 shows schematically the results given in a first, most significative, section of an AK-Master test performed on brake pads produced with the test friction material according to the invention;

FIG. 2 shows schematically the same first section of the same AK-Master test of FIG. 1, but performed on brake pads produced with the reference friction material;

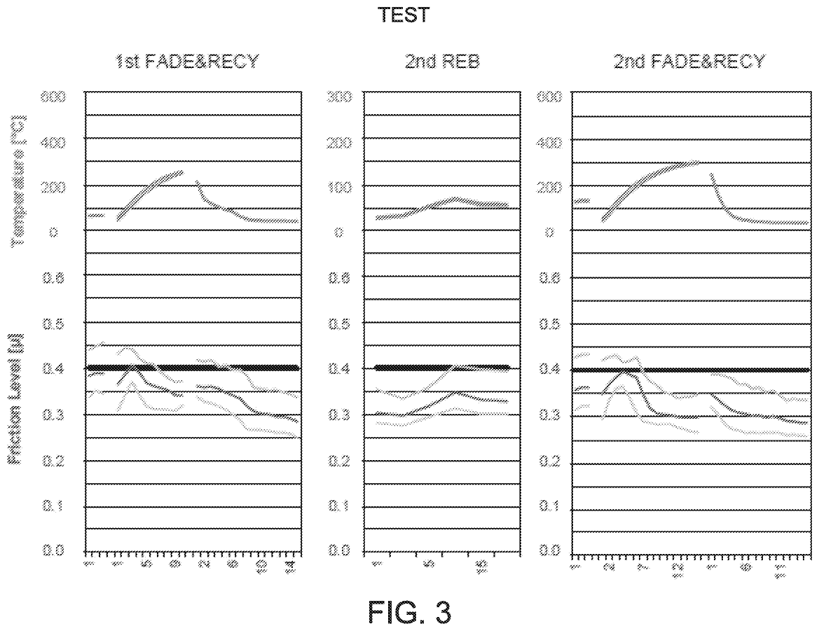

FIG. 3 shows schematically the results given in the FADE section of the same AK-Master test of FIG. 1, obtained with the brake pads produced with the test friction material according to the invention; and

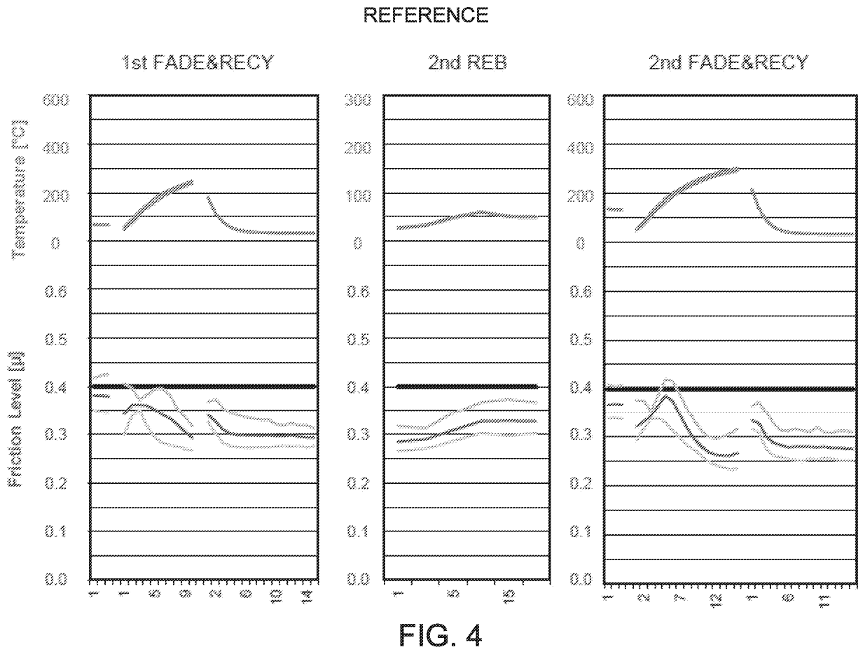

FIG. 4 shows schematically the results given in the FADE section of the same AK-Master test of FIG. 2, obtained with the brake pads produced with the reference friction material.

### DETAILED DESCRIPTION

In more detail, the disclosed asbestos free friction material composition comprises at least one filler, at least a fibrous material, at least one binder, at least one lubricant/friction modifier and at least one or more abrasives according to any of the well-known formulation of friction material compositions available on the market or commonly used to realize brake elements like brake pads or brake shoes.

According to one aspect of the invention, other than the above mentioned standard components, the disclosed friction material composition includes at least one water soluble chemical compound of a metal able to chemically react in presence of water and/or humidity with any of the ions (anions) possibly released/releasable by any of the other aforementioned standard raw material components present in the friction material composition itself to form with such ions water insoluble metal salts, which may remain in use, therefore, captured/sequestered within the friction material block formed with the presently disclosed friction material composition without the possibility to reach the friction partner of the friction material block (e.g. brake disc) possibly causing a chemical etching of the ferrous material thereof.

In particular, the aforementioned water soluble chemical compounds of a metal to be added to any standard friction material composition to avoid/strongly limit the ion release phenomenon consist of one or more metal salts and/or hydroxides easily soluble in water and able, at the same time, to form water insoluble salts with sulfate, sulfite, oxalate and phosphate ions normally present in the friction material composition and/or possibly released thereby.

Preferably, the asbestos free friction material composition of the present disclosure comprises, other than the other standard components of a friction material, at least one water soluble chemical compound of barium and/or calcium and/or aluminum and/or silver, such as barium carbonate, calcium hydroxide, aluminum triacetate and silver acetate.

More preferably, the asbestos free friction material composition of the present disclosure includes, other than the other standard components of a friction material commonly used, a specific quantity of barium carbonate.

The at least one water soluble chemical compound of a metal, which is able to chemically react in presence of water and/or humidity with any of the ions (anions) possibly released/releasable by any of the standard raw material components present in a friction material composition to form with such ions water insoluble metal salts, is present in the friction material composition of the invention in a quantity comprised between 0.5% and 10% by weight calculated on the total weight of the friction material composition, including the extremes of the interval.

Preferably, the friction material composition of the invention includes, other than the standard raw material components of a NAO friction material, from 0.5 to 5% by weight of barium carbonate BaCO₃.

Most preferably, a friction material composition according to the invention includes, other than the standard raw material components of a NAO friction material, about 1% by weight of barium carbonate BaCO₃.

In order to obtain the favorable action of sequestration of the ions possibly released in a friction material composition, it is important that the aforementioned one or more metallic salts and/or hydroxides easily soluble in water and able, at the same time, to form water insoluble salts with sulfate, sulfite, oxalate and phosphate ions, have a specific granulometry and accordingly, a specific surface area such as to promote the chemical reaction of sequestration of the released ions.

Accordingly, in a preferred embodiment, the friction material of the invention may include barium carbonate in a quantity comprised between 0.5 and 1% by weight and having a particle size distribution between 5 and 80 μm (micron).

In any case, the aforementioned one or more metallic salts and/or hydroxides easily soluble in water and able, at the same time, to form water insoluble salts with sulfate, sulfite, oxalate and phosphate ions included in the friction material composition of the invention has to have a granulometry below 100 μm (micron).

It has been demonstrated by experimental tests, in fact, that a granulometry distribution outside the above ranges and specifically higher than 100 micron negatively affects the solubility of the metallic salts and/or hydroxides so rendering them less effective.

Other than the aforementioned one, or more, metallic salts and/or hydroxides easily soluble in water and able, at the same time, to form water insoluble salts with sulfate, sulfite, oxalate and phosphate ions, the raw material components of the friction material according to the invention may be any of the raw material components commonly used in frictional materials already knows in the art.

In particular, the at least one fibrous material may be selected from the group consisting of inorganic fibers, organic fibers, metallic fibers and any combination thereof.

Preferably, the at least one fibrous material consists in organic fibers selected from the group consisting of polyacrylic fibers, polyaramid fibers, aramid fibers, cellulose fibers and mixtures thereof.

The organic fibers may be, preferably but not exclusively, contained in the friction material composition of the present disclosure as a part of the organic binder, since they may have the main object to increase the strength thereof under the operative working conditions of the brake pads/shoes which may be manufactured from the friction material composition of the present disclosure.

The at least one binder is preferably an organic binder and may be selected from the group consisting of phenolic resins, epoxy resins, siliconic resins, modified phenolic resins, melamminic resins, polymmide resins and mixtures thereof.

The at least one lubricant or friction modifier may consist, preferably but not exclusively, of a sulphide-based lubricant selected from the group consisting in metal sulfides of Sn, Zn, Fe, Mo, and mixtures thereof.

Numerous materials can be used as organic or inorganic filler. Preferably, the at least one filler is an inorganic filler selected from the group consisting of mineral fibers, glass fiber, rockwood, phillosilicates (mica, vermiculite, talc, etc.), titanates, inorganic hydroxides of Calcium, Magnesium, Potassium, and any mixture thereof.

The at least one or more abrasives comprise at least one soft/mild abrasive having a Mohs hardness of below 7 and comprised between 1 and 3, at least one medium abrasive having a Mohs hardness of below 7 and comprised between 4 and 6 and at least one hard/strong abrasive having a Mohs hardness of 7 or above 7 and generally comprised between 7 and 9.

Hard abrasives (i.e., having a Mohs hardness of above 7) have, preferably but not exclusively, a roundish-shape and are anyway selected, preferably but not exclusively, in the group consisting of silicon carbide, zirconium sand, zirconium silicate, zirconia, corundum, alumina, mullite, tungsten carbide, zirconium carbide, boron nitride and any mixture thereof.

Medium abrasives (i.e., having a Mohs hardness comprised between 4 and 6) are selected, preferably but not exclusively, in the group consisting of barium sulfate, magnesium oxide, calcium fluoride, calcium carbonate, wollastonite, calcium silicate, iron oxide, silica, chromite, zinc oxide and any mixture thereof.

Soft/mild abrasive (i.e., having a Mohs hardness of between 1 and 3) may be selected, preferably but not exclusively, in the group consisting of talc, calcium hydroxide, potassium titanate, mica, zinc oxides, tin oxides, silicate, fluoride and any mixture thereof.

According to a preferred embodiment of the present invention, the disclosed friction composition may include at least one metal or a mixture of metals, but is copper free.

Here and in the following, the expression “copper-free” is to be understood to imply a content of copper and/or of copper containing materials, like copper alloys, of, or lower than, 0.5% by weight.

The at least one metal or a mixture of metals, when present in the disclosed friction material composition, does not consists of copper and/or any copper alloys, but it is selected from the group consisting of iron, steel, stainless steel, tin, zinc, and any alloy thereof in powder or fiber form.

In addition, the disclosed friction material composition may comprise organic additives selected from the group consisting of polytetrafluoroethylene, friction dust, cashew dust, rubbers (i.e., NBR, siliconic, SBR, etc.).

In addition, the disclosed friction material composition may comprise carbonaceous materials, like carbon, carbon black, coke, graphite and mixtures thereof.

In a further embodiment of the present invention, the disclosed average friction material composition is as follows (% is in weight):

| | |
|---|---|
| ABRASIVE MOHS 7-9 | 08-15% |
| ABRASIVE MOHS 4-6 | 05-15% |
| ABRASIVE MOHS 1-3 | 20-30% |
| BINDER (RESIN) | 10-20% |
| ORGANIC ADDITIVES | 08-15% |
| FIBERS | 03-10% |
| LUBRICANTS | 02-08% |
| CARBON | 05-15% |
| BARIUM CARBONATE (5-80 μm) | 0.5-10% |

The invention lastly also extends to a brake element, in particular a brake pad or shoe, presenting a layer or block of friction material made from the friction material composition described above in any known and usual manner, e.g. by molding.

The invention further extends to a braking system comprising a member to be braked, constituted by a brake disc or brake drum made of cast iron or steel and by at least one braking element constituted by a brake pad or shoe which is designed to cooperate by means of friction with the member to be braked, wherein the braking member presents a friction layer or block which is intended to cooperate with the member to be braked and which is made of the friction material composition as described above.

### Exemplary Modes of Carrying Out the Teachings of the Present Disclosure

Inventive and comparative examples are reported here by way of illustration and are not intended to limit the invention.

### Example 1

A number of samples of friction material compounds of different chemical composition and of corresponding reference samples are prepared with the percentage proportions (in weight) reported in Table 1 and according to different known NAO standard compositions.

TABLE 1

| | TEST | REFERENCE |
|---|---|---|
| | SAMPLES | SAMPLE |
| RAW COMPONENTS | (% W) | (% W) |
| HARD ABRASIVE (MOHS 7-9) | 08-15% | 08-15% |
| MEDIUM ABRASIVE (MOHS 4-6) | 05-15% | 05-15% |
| MILD ABRASIVE (MOHS 1-3) | 20-30% | 20-30% |
| BINDER (PHENOLIC RESIN) | 10-20% | 10-20% |
| ORGANIC ADDITIVES | 08-15% | 08-15% |
| FIBERS | 03-10% | 03-10% |
| LUBRICANTS/FRICTION | 02-08% | 02-08% |
| MODIFIERS | | |
| CARBONACEUS MATERIAL | 05-15% | 05-15% |
| BARIUM CARBONATE (5-80 | 0.5-10% | — |
| μm particle size) | | |

All the reference samples have the same chemical composition of the corresponding test samples except the barium carbonate, which is missing.

The components shown in Table 1 were uniformly mixed in a Horizontal Mixer (e.g., Loedige kind mixer) and molded in a mold onto identical metal flat supports and then cured in conventional manner, in order to form identical brake pads except for the chemical composition of friction materials.

In particular, the brake pad pressing was performed at a temperature of between 6° and 200° C. at a pressure from 150 to 1800 kg/cm² for a duration of between 3 and 10 minutes or else in preforming the mixing within a mold and thereafter pressing at a temperature from 130 to 180° C. at a pressure from 150 to 500 kg/cm² for a duration of from 3 to 10 minutes.

Each resulting pressed article is typically post-cured by means of heat treatment from 150 to 400° C. for a duration of between 10 minutes to 10 hours, it is then spray painted or powder-painted and kiln-dried to produce the final product.

### Example 2: Sulphate Release Test

The brake pads obtained in Example 1 were subjected each individually to a sulphate release test.

The test procedure is as follows:
Collect 4 g of friction material powder;
Boil the collected friction material powder for 8 h in 100 ml of water at 90° C. in a closed system;
Transfer the resulting solution in a 100 ml cylinder and make up to 100 ml with distilled water;
Perform a standard SO₄ chromatography analysis of the diluted solution so obtained.

The measured results of the sulphate release tests, carried out on all the prepared samples (test and reference), have given the average values as reported in Table 2 below.

TABLE 2

| sample | SO₄ concentration (mg/L) |
|---|---|
| Reference Friction material | 120 |
| Friction materials with BaCO₃ | 4.5 |

As it is immediately evident from Table 2, the addition of barium carbonate within the ranges indicated in Table 1 brings invariably to a dramatical reduction (more of 20 folds) of the release of sulphate ions from the tested friction material blocks, irrespective of composition variation within the ranges indicated in Table 1 apparently due to the chemical sequestration of the sulphate ions by the salt of barium carbonate, which converts itself into Ba(SO₄) which, being a water insoluble salt, remain trapped in the friction material block instead of being released in the water solution.

A chemical analysis of the residual friction material powder after the release test shows that barium of BaCO₃ has formed insoluble salt with any of sulphate, oxalates, and phosphates and has precipitated as BaSO₄, Ba₃(PO₄)₂, BaC₂O₄ and BaCro₄.

### Example 3

Operating as described in examples 1 and 2, a number of identical test friction material compositions and one reference composition are prepared according to the average value of the content ranges indicated in Table 1, by replacing in the test samples the barium carbonate with, respectively, Calcium hydroxide Ca(OH)₂, Aluminum triacetate Al(CH3COO)₃ and Silver acetate CH₃COOAg.

An ion release test is then carried out on the obtained test and reference samples operating in the same manner as described in Example 2, but looking for the concentration in the water solution different ions, namely (PO₄)₂³⁻, SO₄²⁻ and Cl⁻.

Again, the final results shown a decrease in the release of those ions of more than 10-15 folds with respect to the reference sample.

A chemical analysis of the residual friction material powder after the release test shows that:
Calcium hydroxide Ca(OH)₂ leads to precipitation of Ca₃(PO₄)₂ and CaSO₃.
Aluminum triacetate Al(CH₃COO)₃ reduces release of phosphate, forming insoluble of AlPO₄.
Silver acetate CH₃COOAg leads to precipitation of AgCl, Ag₃PO₄, Ag₂SO₃.

It stems from the above that all the metallic chemical compounds tested are similarly effective in reducing dramatically the ion release phenomenon in standard NAO friction material compositions.

### Example 4

Four friction material samples were prepared using the same average values of each component as listed in Table 1 and with reference to the ranges shown in Table 1, but using different contents (% weight) of barium carbonate, namely: 0.5%, 18, 2%, 5% in order to check the effect of barium concentration in scavenging of sulfate ions.

After obtaining sample brake pads as described in Example 1 and after execution of the release test as described in Example 2, the SO₄ concentration in the residual water solution was measured. The results are reported in following Table 3.

TABLE 3

| sample | SO₄ concentration (mg/L) |
|---|---|
| Reference Friction material | 120 |
| Friction materials with 0.5% BaCO₃ | 15 |
| Friction materials with 1% BaCO₃ | 4.5 |
| Friction materials with 2% BaCO₃ | 6 |
| Friction materials with 5% BaCO₃ | 7.5 |

As it may be noticed, the addition of BaCO₃ in a NAO friction material composition always decreases drastically the amount of sulphate ions released, at all concentrations of Barium carbonate.

Surprisingly, the lowest value of released sulphate is obtained at a concentration of BaCO₃ of 1%, which not only is enough to reduce the release of SO₄ ions in solution indicating that higher concentrations (e.g., 28, 5%) are not needed, but, above all, represent a particularly advantageous critical concentration.

Finally, the experimental tests carried out by the technical people of the Applicant have shown that also the granulometry distribution of the metal salt/hydroxide to be used for contrasting the ion release phenomenon is of paramount importance. In particular, it has been proved that a granulometry over 100 micron decreases the effectiveness of the sequestration of the released ions.

### Example 5: Braking Performance Test

Brake pads produced according to Example 1, containing (test pads) or not containing (reference pads) 1% in weight of BaCO₃ are subjected to a standard AK-Master braking test. The most significant part of the graphic results is shown in FIGS. 1 and 2.

As the skilled person may easily see, FIGS. 1 and 2 show the friction coefficient μ (max, med and min) during an efficiency test composed by three brake section of ten braking in each section, as follows:
First section: from 50 km/h to 0 km/h
Second section: from 100 km/h to 0 km/h
Third section: from 120 km/h to 0 km/h

Looking at the figures, it may be appreciated that a target objective in relation to standard performances is reached: at a deceleration of 6 m/s² the coefficient of friction u remains higher than 0.3 and the measured pad wear is lower than 1.2 mm, for both materials (test and reference).

Considering now FIGS. 3 And 4, they show the FADE section of the same AK-Master test of FIGS. 1 and 2. FIGS. 3 and 4 show the variability of the friction coefficient μ (max, med, and min.) with increasing temperature (upper part of the figures). The different temperatures are due to the execution of different braking cycles. Also in this case the coefficient of friction remains within a target value of μ>0.25.

As it can be noticed, the behavior of both tested brake pads (test and reference) is very similar and satisfies all the standard market requirements in all section. This indicates that the presence of BaCO₃ in the friction mixture do not affect braking performances, though being very effective in solving the problem of the ion release.

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, features, certain elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. An asbestos free friction material composition comprising, as raw component materials thereof:
at least one filler;
at least a fibrous material selected from the group consisting of inorganic fibers, organic fibers, metallic fibers and any combination thereof;
at least one binder;
at least one lubricant or friction modifier; and
at least one or more abrasives, wherein in combination, it the friction material composition further comprises at least one water soluble chemical compound of a metal, which chemical compound is able to chemically react in presence of water and/or humidity with ions released or releasable by any of said raw material components present in the friction material composition itself to form with such ions water insoluble metal salts.

2. The asbestos free friction material composition according to claim 1, wherein said water soluble chemical compounds of the metal consist of a metal salt and/or a metal hydroxide easily soluble in water and able, at the same time, to form water insoluble salts with sulfate, sulfite, oxalate and phosphate ions normally present in the friction material composition and/or released thereby.

3. The asbestos free friction material composition according to claim 1, wherein the metal in said at least one water soluble chemical compound of the metal is chosen in the group consisting in of barium, calcium, aluminum, silver, and any combination thereof.

4. The asbestos free friction material composition according to claim 1, wherein said at least one water soluble chemical compound of the metal consists in a salt or hydroxide chosen from the group consisting of: barium carbonate, calcium hydroxide, aluminum triacetate and silver acetate.

5. The asbestos free friction material composition according to claim 1, wherein the friction material composition includes a specific quantity of barium carbonate comprised between 0.5 and 10% by weight.

6. The asbestos free friction material composition according to claim 1, wherein the friction material composition includes barium carbonate having a particle size distribution between 5 and 80 μm (micron).

7. The asbestos free friction material composition according to claim 5, wherein the friction material composition includes from 0.5 to 5% by weight of barium carbonate BaCO₃ having a particle size distribution between 5 and 80 μm (micron).

8. The asbestos free friction material composition according to claim 1, wherein said at least one water soluble chemical compound of the metal is present in the friction material composition in a quantity comprised between 0.5% and 10% by weight calculated on the total weight of the friction material composition, including the extremes of the interval, and having a granulometry below 100 μm (micron).

9. The asbestos free friction material composition according to claim 1, wherein the friction material composition includes about 1% by weight of barium carbonate BaCO₃ having a particle size between 5-80 micron.

10. A brake element for a vehicle comprising:
a metallic support; and
a layer or block of friction material carried by the support, the block of friction material being made by an asbestos free friction material composition preferably having been molded upon a first face of the support, wherein
the asbestos free friction material composition comprises, as raw component materials thereof:
at least one filler;
at least a fibrous material selected from the group consisting of inorganic fibers, organic fibers, metallic fibers and any combination thereof;
at least one binder;
at least one lubricant or friction modifier; and
at least one or more abrasives,
wherein
in combination, the friction material composition further comprises at least one water soluble chemical compound of a metal, which chemical compound is able to chemically react in presence of water and/or humidity with ions released or releasable by any of said raw material components present in the friction material composition itself to form with such ions water insoluble metal salts, and
wherein
captured or sequestered within the friction material thereof or onto it the friction material any ion released by one or more of the component materials of the friction material composition in the form of a water insoluble metal salt without the possibility for the ions to reach a friction partner of the block of friction material, causing a chemical etching of the ferrous material thereof.

11. The brake element according to claim 10, wherein the brake element is a brake pad or brake shoe.

12. A braking system comprising:
a member to be braked, constituted by a brake disc or brake drum made of cast iron or steel; and
at least one braking member constituted by a brake pad or brake shoe, adapted to cooperate by friction with the member to be braked, wherein the braking member has a friction layer intended to cooperate with the member to be braked made of a friction material composition, the friction material composition comprising, as raw component materials thereof:
at least one filler;
at least a fibrous material selected from the group consisting of inorganic fibers, organic fibers, metallic fibers and any combination thereof;
at least one binder;
at least one lubricant or friction modifier; and
at least one or more abrasives, wherein in combination, the friction material composition further comprises at least one water soluble chemical compound of a metal, which chemical compound is able to chemically react in presence of water and/or humidity with ions released or releasable by any of said raw material components present in the friction material composition itself to form with such ions water insoluble metal salts.

13. The brake element according to claim 10, wherein said water soluble chemical compounds of the metal consist of a metal salt and/or a metal hydroxide easily soluble in water and able, at the same time, to form water insoluble salts with sulfate, sulfite, oxalate and phosphate ions normally present in the friction material composition and/or released thereby.

14. The brake element according to claim 10, wherein the metal in said at least one water soluble chemical compound of the metal is chosen in the group consisting of: barium, calcium, aluminum, silver, and any combination thereof.

15. The brake element according to claim 10, wherein said at least one water soluble chemical compound of the metal consists in a salt or hydroxide chosen from the group consisting of: barium carbonate, calcium hydroxide, aluminum triacetate and silver acetate.

16. The braking system according to claim 12, wherein said water soluble chemical compounds of the metal consist of a metal salt and/or a metal hydroxide easily soluble in water and able, at the same time, to form water insoluble salts with sulfate, sulfite, oxalate and phosphate ions normally present in the friction material composition and/or released thereby.

17. The braking system according to claim 12, wherein the metal in said at least one water soluble chemical compound of the metal is chosen in the group consisting of: barium, calcium, aluminum, silver, and any combination thereof.

18. The braking system according to claim 12, wherein said at least one water soluble chemical compound of the metal consists in a salt or hydroxide chosen from the group consisting of: barium carbonate, calcium hydroxide, aluminum triacetate and silver acetate.
